(19) United States
(12) Patent Application Publication
(10) Pub. No.: US 2015/0111530 A1
(43) Pub. Date: Apr. 23, 2015

(54) METHOD AND APPARATUS FOR PROCESSING CHARGING REQUEST

(71) Applicant: Alcatel Lucent, Boulogne Billancourt (FR)

(72) Inventor: Xiangyang Li, Shanghai (CN)

(21) Appl. No.: 14/396,242

(22) PCT Filed: Apr. 15, 2013
(86) PCT No.: PCT/IB2013/000908

§ 371 Date: Oct. 22, 2014

(30) Foreign Application Priority Data
Apr. 23, 2012 (CN) 201210131095.1

(51) Int. Cl. H04M 15/00

(52) U.S. Cl. CPC H04M 15/41
USPC 455/406

(57) ABSTRACT

The present invention provides a method and apparatus for processing a charging request. Upon receipt of the charging request, a merged charging System will determine the types of all charging activities related to the charging request and a charging entity corresponding to each type of the charging activities based on the information contained in the charging request. First, some rules are preset in the merged charging System; then, these rules are executed in sequence based on the information contained in the charging request, and for a rule whose condition is met, its corresponding charging entity is determined. Next, charging is performed simultaneously on all the determined charging entities, and a piece of charging information record is generated for each of the charging entities. By using the present method, the merging of B2C charging and B2B charging can be implemented with only one charging System, which covers almost all charging activities; and thereby the present invention can dramatically reduce the costs for construction and maintenance, save valuable network resources, and improve processing efficiency.

### TECHNICAL FIELD

The present invention relates to a communications network, and more particularly, to a method and apparatus for processing a charging request in the communications network.

### TECHNICAL BACKGROUND

At present, the charging in a telecommunication network is mainly divided into two types: B2C (Business to Customer) charging and B2B (Business to Business) charging.

The B2C charging refers to charging by a network operator with respect to its end users. An end user pre-selects a certain charging plan so as to use the network resources and services provided by the network operator who then charges the end user according to the predetermined charging plan. For example, both the current pre-payment service and the post-payment service belong to the B2C charging.

The B2B charging refers to how a network operator shares fees obtained from end users with its collaborating partners. Generally, an operator and its collaborating partners (for example, a content provider, a roaming collaborating operator, an interconnect collaborating operator) provide services in collaboration to end users according to a pre-agreed agreement; after the end user uses these services, the network operator shares revenues with its collaborating partners according to the pre-agreed agreement.

FIG. 1 shows various kinds of major charging activities involved in the current communications network, wherein type 1 is end user charging, type 2 is wholesale charging, type 3 is revenue sharing charging, type 4 is interconnect settlement charging, and type 5 is roaming charging.

End user charging: it occurs between an end user and a network operator (or a virtual network operator). The network operator or virtual network operator provides services to end users, thereby charging the end users accordingly.

Wholesale charging: it occurs between a network operator and a virtual network operator. The network operator wholesales products and/or services to the virtual network operator with a lower price; the virtual network operator then retails these products and/or services to end users with its own brand. The wholesale charging refers to how the virtual network operator pays the network operator for its wholesaled products and/or services.

Revenue sharing charging: it occurs between a network operator (or a virtual network operator) and a content provider. The content provider provides contents or services to end users via the network operator. The revenue sharing charging refers to how to share and allocate the revenues obtained from the end users between the network operator and the content provider.

Interconnect settlement charging: it occurs between a network operator A and another network operator B. In fact, such situation always occurs that a call of an end user is initiated (or terminated) at a network of the operator A, but is terminated (or initiated) at the network of the other operator B. The interconnect settlement charging refers to how the network operator A charges the network operator B due to network interconnections.

Roaming charging: it occurs between a mobile network operator A1 and its collaborating operator A2. Roaming means that when a mobile user leaves his/her local area or his/her country (i.e., the network of operator A1), he/she can still use his/her mobile phone in some other areas or countries (i.e., the network of operator A2). Roaming charging refers to how the mobile network operator A1 pays the operator A2 with regard to the roaming.

Herein, the end user charging belongs to the B2C charging, while the wholesale charging, revenue sharing charging, interconnect settlement charging and roaming charging belong to the B2B charging.

Currently, operators each use different systems provided by different manufacturers to operate and maintain the B2C charging and B2B charging. For example, the pre-payment system is provided by a manufacturer A; the post-payment system is provided by a manufacturer B, while the revenue sharing charging and the interconnect settlement charging are provided by a manufacturer C. However, some functions of these systems are repetitive, and for an operator, it not only costs dearly and wastes resources and is also not convenient for operation and maintenance when using multiple charging systems. Thus, most operators are seeking a unified and merged charging plan, which can not only support the pre-payment charging and post-payment charging, but also have the functions of the B2B charging. Such unified charging plan should cover almost all charging activities occurring in the operator network.

Although the 3GPP standard defines a merged online charging (i.e. pre-payment charging) and offline charging (post-payment charging) system to specify how an operator charges end users, it merely addresses the merging issue of the B2C charging, without solving the problem of how to merge the B2B charging and the B2C charging into a single system.

### SUMMARY OF THE INVENTION

In order to solve the above deficiencies in the prior art, the present invention provides a method and apparatus for processing a charging request.

According to a first aspect of the present invention, there is provided a method for processing a charging request in a server, the method comprising the following steps: A. receiving a charging request for a session or a user event; B. determining types of all charging activities related to the charging request and a charging entity corresponding to each type of the charging activities according to information contained in the charging request; C. charging all the determined charging entities simultaneously and generating a piece of charging information record for each of the charging entities; and D. sending the charging information records.

Preferably, step B further comprises the following steps: B1. presetting a plurality of rules that are in one-to-one correspondence with one type of the charging activities; B2. executing the plurality of rules based on the information contained in the charging request, and for a rule whose condition is met, determining its corresponding charging entity.

Preferably, step C further comprises: for each of the determined charging entities, performing the following steps: C1. querying a charging plan and account information corresponding to the charging entity; C2. calculating fee information for the current usage based on the charging plan, and updating the corresponding account information; C3. generating a piece of charging information record based on the fee information for the current usage and the updated account information.

Preferably, the types of the charging activities comprise one of the following types: end user charging, wholesale charging, revenue sharing charging, interconnect settlement charging, and roaming charging.

Preferably, the information contained in the charging request comprises at least one or more of the following information: caller identification, callee identification, user location information, whether being in a roaming state, a call direction, interconnect operator identification, network information, information of the used services, service provider information, and amount of the used network resources.

Preferably, the charging information record comprises at least the following information: account information, a charging plan, and fee information for the current usage.

According to a second aspect of the present invention, there is provided an apparatus for processing a charging request in a server, the apparatus comprising: a receiving device configured to receive a charging request for a session or a user event; a charging entity determining device configured to determine types of all charging activities related to the charging request and a charging entity corresponding to each type of the charging activities according to information contained in the charging request; a charging device configured to charge all the determined charging entities simultaneously and generate a piece of charging information record for each of the charging entities; and a sending device configured to send the charging information records.

Preferably, the charging entity determining device further comprises: a rule setting device configured to preset a plurality of rules that are in one-to-one correspondence with one type of the charging activities; a rule executing device configured to execute the plurality of rules based on the information contained in the charging request, and determine a corresponding charging entity for a rule whose condition is met.

Preferably, a fee calculating device further comprises a querying device, a charging device, and a generating device, wherein for each of the determined charging entities, the querying device is configured to query a charging plan and account information corresponding to the charging entity; the fee calculating device is configured to calculate the fee information for the current usage based on the charging plan and update the corresponding account information; and the generating device is configured to generate a piece of charging information record based on the fee information for the current usage and the updated account information.

Preferably, the types of the charging activities comprise one of the following types: end user charging, wholesale charging, revenue sharing charging, interconnect settlement charging, and roaming charging.

Preferably, the information contained in the charging request comprises at least one or more of the following information: caller identification, callee identification, user location information, whether being in a roaming state, a call direction, interconnect operator identification, network information, information of the used services, service provider information, and amount of the used network resources.

Preferably, the charging information record comprises at least the following information: account information, a charging plan, and fee information for the current usage.

Compared with the prior art, the present invention provides a merged charging system capable of processing the B2C charging and B2B charging simultaneously. Almost all charging activities may be processed merely by using one charging system, without adopting multiple independent and separate charging systems. Apparently, the present invention has the following beneficial effects: 1) reducing the cost for constructing a system since the cost for constructing multiple separate charging systems with overlapping functions is apparently higher than the cost for constructing one merged charging system; 2) reducing the workload at the backend since an operating staff can conduct subsequent works by viewing the data of one system only; 3) reducing the maintenance cost since the manpower and material resources required for maintaining one system are apparently lower than the manpower and material resources required for maintaining multiple separate systems.

### BRIEF DESCRIPTION OF THE DRAWINGS

Other features, objectives and advantages of the present invention will become more apparent through reading the following detailed description of the non-limiting embodiments with reference to the accompanying drawings.

FIG. 1 shows a schematic diagram of various major charging activities involved in a mobile network;

FIG. 2 shows a schematic diagram of a system for processing a charging request according to one specific embodiment of the present invention;

FIG. 3 shows a flowchart of a method for processing a charging request according to one specific embodiment of the present invention;

FIG. 4 shows a flowchart of a sub-step of a method for processing a charging request according to one specific embodiment of the present invention;

FIG. 5 shows a flowchart of a sub-step of a method for processing a charging request according to one specific embodiment of the present invention;

FIG. 6 shows a schematic diagram of an application scenario for a method for processing a charging request according to one specific embodiment of the present invention; and

FIG. 7 shows a structural block diagram of an apparatus for processing a charging request according to one specific embodiment of the present invention.

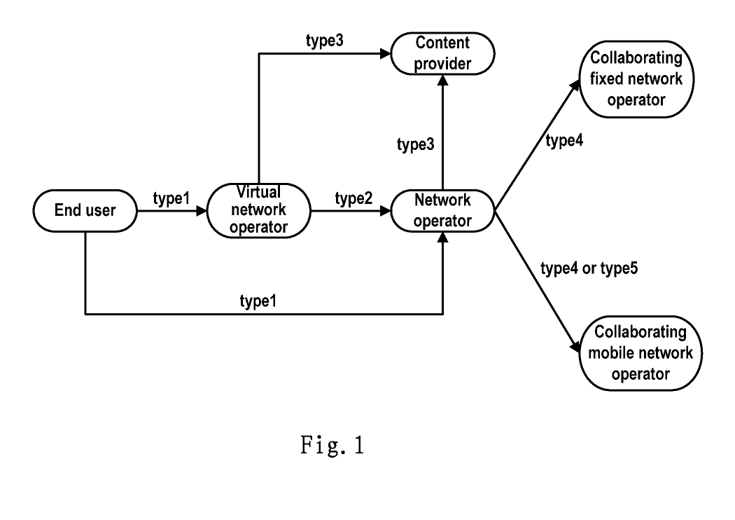

### DETAILED DESCRIPTION OF THE PREFERRED EMBODIMENTS

A basic idea of the present invention lies in: processing various charging activities with only one system; and specifically, for a session or a user event, obtaining types of all charging activities involved therein and a charging entity corresponding to each type of the charging activities by adopting the method and apparatus of the present invention.

First, illustrations for a few concepts will be made.

[Charging activity]: a fee relationship occurring between network entities due to use of network resources.

[Type of charging activities]: there are five usual types in the current communications network, which are: end user charging, wholesale charging, revenue sharing charging, interconnect settlement charging, and roaming charging, respectively. With regard to the explanations of each type, please refer to the Background section.

[Session]: the session used herein generally refers to network use with a certain time length of the network use, for example, voice call, and data session, etc.

[Event]: the event used herein generally refers to network use charged per times. For example, SMS (short message service), and MMS (multimedia message service), etc.

[Charging entity]: it refers to a network entity creating a fee relationship, mainly used for identifying account information and a charging plan. It is generally divided into a paying party or a charging party, and in some cases, they may be a <paying party−charging party> pair, because a same charging party may charge different paying parties using different charging plans.

Hereinafter, the present invention will be described in detail with reference to various accompanying drawings.

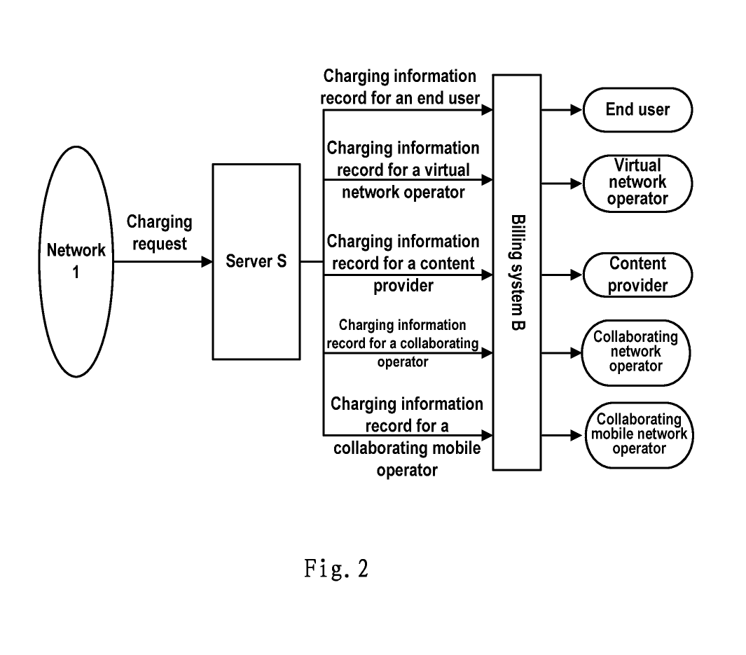

FIG. 2 shows a schematic diagram of a system for processing a charging request according to one specific embodiment of the present invention.

Herein, a server S receives a charging request from a network 1, wherein the charging request may come from the following network elements in the network 1: MSC (Mobile Switch Center), SGSN (Serving GPRS SUPPORT NODE), P-GW/PCEF (Packet data network—GateWay/Policy and Charging Enforcement Function), IMS GW (IMS GateWay), IMS AS (IMS Application Server), WLAN (Wireless Local Access Network), IMS MRFC (IMS Multimedia Resource Function Controller), MMS server, MBMS (Multimedia Broadcast Multicast Service) server, PoC (Push-To-Talk over Cellular), and SMS node, etc.

The charging request is directed to a session or a user event.

The server S will determine the types of all charging activities related to the charging request and generate a piece of charging information record for each type. If the charging request contains the end user charging, then the server S generates a piece of charging information record for an end user; if the charging request contains the wholesale charging, then the server S generates a piece of charging information record for a virtual network operator; if the charging request contains the revenue sharing charging, then the server S generates a piece of charging information record for a content provider; if the charging request contains the interconnect settlement charging, then the server S generates a piece of charging information record for a collaborating operator; and if the charging request contains the roaming charging, then the server S generates a piece of charging information record for a collaborating mobile operator.

As illustrated in FIG. 2, the server S sends all generated charging information records to a billing system B. After being processed, the billing system B sends to the end user, the virtual network operator, the content provider, the collaborating operator, and the collaborating mobile operator their corresponding bills.

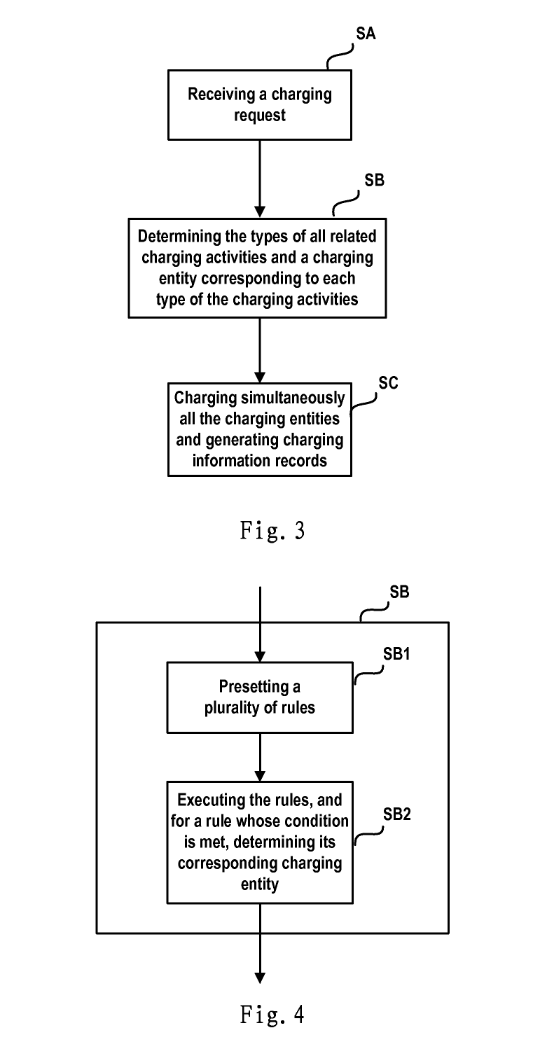

FIG. 3 shows a flowchart of a method for processing a charging request in a server S according to one specific embodiment of the present invention. As illustrated in the figure, the method starts from step SA.

In step SA, the server S receives a charging request from a network 1. The charging request is directed to a session or a user event. The charging request may contain, but not limited to, one or more of the following information:

caller identification, for example the MSIDSN (Mobile Station International ISDN Number, IMSI (International Mobile Subscriber Identity), and MDN (Mobile Directory Number) etc. of the caller;

callee identification, for example, the MSIDSN, IMSI, and MDN etc. of the callee;

call direction, for example, outgoing or incoming, etc.;

APN (access point number), which is only directed to data;

user location information, for example, Cell number, MCC (mobile country code), MNC (mobile national code), etc.;

user equipment information, for example, Apple smartphones, etc.;

network information, for example, the address of Serving-Gateway;

identification of an interconnect operator;

network resource use information, for example, call duration, data upload/download traffic, number of Short Messages/Multimedia Messages, etc.;

access technology, for example, traditional voice, GPRS, UMTS, LTE, WLAN, etc.;

QoS (Quality of Service);

service type, for example, voice, SMS, MMS, IMS, PoC, content, application, and ring tone, etc.;

service provider information, for example, identification of merchants, identification of content providers, and identification of application providers etc.

Next, in step SB, the server S determines the types of all charging activities related to the charging request and a charging entity corresponding to each type of the charging activities in accordance with the information contained in the charging request, wherein the information for determining the types of the charging activities and the charging entity corresponding to each type of the charging activities may be any in the information contained in the charging request as listed above, but not limited to the above information.

Alternatively, the types of the charging activities may be one of the following types:
end user charging;
wholesale charging;
revenue sharing charging;
interconnect settlement charging;
roaming charging.

Then, in step SC, the server S charges all charging entities determined in step

SB simultaneously and generates a piece of charging information record for each of the charging entities.

Next, in step SD, the server S sends all charging information records generated in step SC to the billing system B.

FIG. 4 shows a flowchart of step SB according to one specific embodiment of the present invention. As illustrated in the figure, in the present embodiment, step SB further comprises step SB1 and step SB2.

In step SB1, the server S presets a plurality of rules that are in one-to-one correspondence with a certain type of the charging activities, for determining a charging entity corresponding to that type of the charging activities. Rules preset in a group of servers Ss will be exemplarily listed below, wherein rule 1 corresponds to the end user charging; rule 2 corresponds to the wholesale charging; rule 3 corresponds to the revenue sharing charging; rule 4 corresponds to the interconnect settlement charging; and rule 5 corresponds to the roaming charging.

Rule 1: IF <Condition 1> THEN <paying party=caller, charging party=operator>.

Rule 2: IF <Condition 2> THEN <paying party=virtual operator, charging party=operator>.

Rule 3: IF <Condition 3> THEN <paying party=content provider, charging party=operator>.

Rule 4: IF <Condition 4> THEN <paying party=operator A, charging party=operator B.

Rule 5: IF <Condition 5> THEN <paying party=mobile operator A1, charging party=mobile operator A2>.

Then, in step SB2, the server S executes all of the above rules in sequence in accordance with the information contained in the charging request, and for the rules whose conditions are met, determines their corresponding charging entities. For example, for a set of rules exemplarily listed above, the server S will execute rule 1, rule 2, rule 3, rule 4, and rule 5 in sequence; if the conditions in rule 1 and rule 5 are satisfied, then for these two rules, the server S will determine the charging entities corresponding to rule 1 and rule 5, respectively.

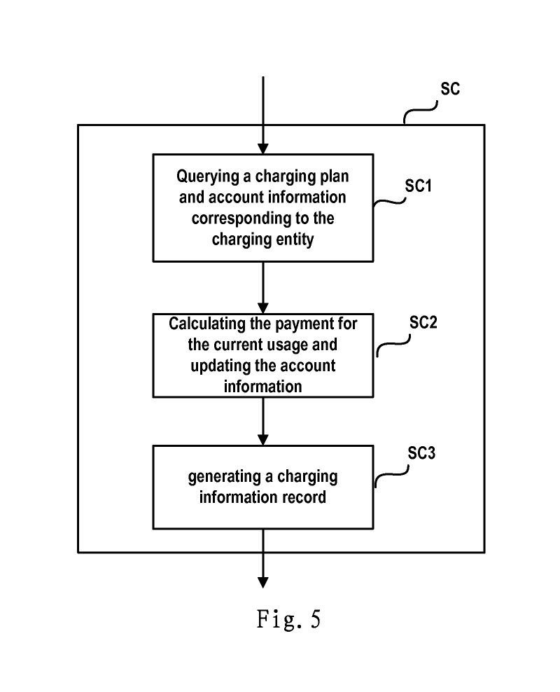

FIG. 5 shows a flowchart of step SC according to one specific embodiment of the present invention. As shown in the figure, in this embodiment, step SC further comprises step SC1, step SC2 and step SC3.

For each of the charging entities determined in step SB, the server S performs step SC1, step SC2 and step SC3 in sequence.

In step SC1, the server S will query the charging plan and account information corresponding to the charging entity. The server S will query a charging plan as maintained in a database (not shown in the figure) corresponding to the charging entity according to the identification of the charging entity, for example, a fee per minute or a fee per byte, etc., and meanwhile query its corresponding account information, i.e., such information as the current account balance of the charging entity.

Then, in step SC2, the server S calculates fee information for the current usage according to the charging plan obtained in step SC1, and updates the account information corresponding to the charging entity. The server S may calculate the fee information for the current usage according to the charging plan and the information contained in the charging request; then, correspondingly, the fee information for the current usage is deducted from the account balance corresponding to the charging entity.

Next, the server S generates a piece of charging information record corresponding to the charging entity based on the fee information for the current usage and the updated account information. The charging information record may include, but not limited to, one or more of the following information:
information contained in the charging request;
account information, for example, account identification, balance, outstanding payment, etc.;
a charging plan, for example, a fee per minute, a fee per byte, and a fee per SMS, etc.,
fee information for the current usage, for example, a fee before discounting, a fee after discounting, discounted amount, discounting ratio, etc.

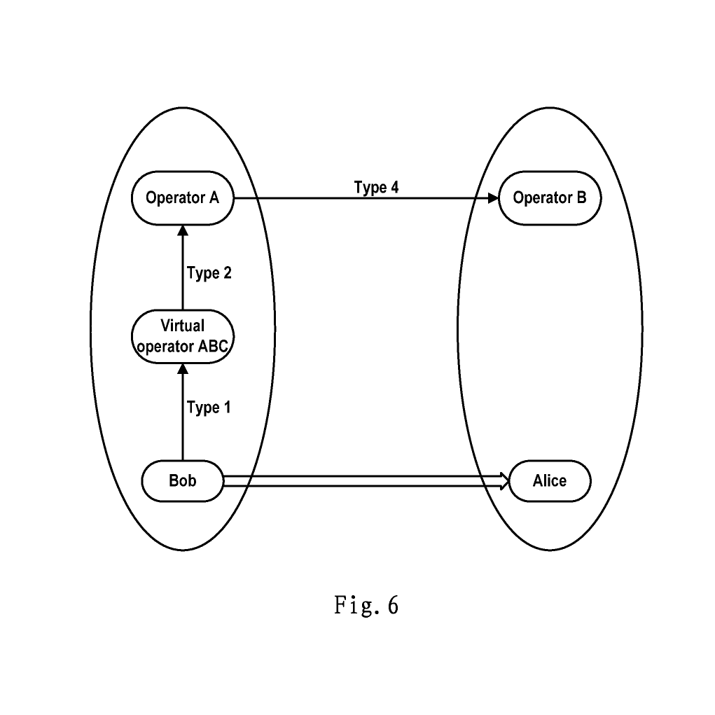

FIG. 6 shows a schematic diagram of an application scenario of a method for processing a charging request according to one specific embodiment of the present invention. In this embodiment, the operator A is an operator located in the USA. A virtual operator ABC provides services to end users by renting the products and networks of the operator A. User Bob is a user under the virtual operator ABC. The operator B is an operator located in Italy. User Alice is a user under the operator B.

User Bob initiates a call to user Alice. This call involves 3 types of charging activities:
end user charging: user Bob pays 30 USD to the virtual operator ABC;
wholesale charging: the virtual operator ABC pays 21 USD to the operator A;
interconnect settlement charging: the operator A pays 3 USD to the operator B, because the operator A needs to use the network resources of the operator B.

Hereinafter, the processing process comprising steps S601 to S607 of the merged charging system S1 of the operator A will be described in detail.

Step S601, the merged charging system S1 receives a charging request that is directed to a call from user Bob to user Alice.

Step S602, the following rules are preset in the merged charging system S1, each rule being in one-to-one correspondence with one type of the charging activities, wherein rule A corresponds to the end user charging; rule B corresponds to the wholesale charging; and rule C corresponds to the interconnect settlement charging.

Rule A: IF call direction=outgoing and call type=voice

THEN charging entity=caller.

Rule B: IF prefix of the caller identification=123, and call direction=outgoing and call type=voice

THEN charging entity=virtual operator ABC.

Rule C: IF prefix of the caller identification=123, and call direction=outgoing and prefix of the callee identification=3912, and call type=voice

THEN charging entity=operator A.

In step S603, the merged charging system S1 executes the abovementioned rule A, rule B, and rule C according to the information contained in the charging request. For rule A, if the conditions are satisfied, it is then determined that the charging request contains the end user charging, and the corresponding charging entity is user Bob; for rule B, if the conditions are satisfied, it is then determined that the charging request contains the wholesale charging, and the corresponding charging entity is the virtual operator ABC; for rule C, if the conditions are satisfied, it is then determined that the charging request contains the interconnect settlement charging, and the corresponding charging entity is the operator A.

For each of the charging entities as determined in step S603, steps S604 to step S606 are executed in sequence.

In step S604, a charging plan and account information corresponding to a charging entity are queried. For user Bob, the charging plan and account information corresponding to Bob are queried; for the virtual operator ABC, the charging plan and account information corresponding to the virtual operator ABC are queried; and for the operator A, the charging plan and account information corresponding to the operator A are queried.

In step S605, a fee for the current call is calculated according to the charging plan derived in step S604 and its corresponding account information is updated. For user Bob, it is calculated that the fee for the current call is 30 USD, and Bob's account information is updated; for the virtual operator ABC, it is calculated that the fee for the current call is 21 USD, and the virtual operator ABC's account information is updated; and for the operator A, it is calculated that the fee for the current call is 3 USD, and the operator A's account information is updated.

In step S606, a piece of charging information record is generated based on the calculated fee for the current call and the updated account information. For user Bob, a piece of charging information record comprising at least Bob's account information, charging plan, fee for the current call is generated; for the virtual operator ABC, a piece of charging information record comprising at least the account information, charging plan, and fee for the current call of the vertical operator ABC is generated; for the operator A, a piece of charging information record comprising at least the account information, charging plan, and fee for the current call of the operator A is generated.

In step S607, the merged charging system S1 sends all the generated charging information records to the billing system, i.e., sending the charging information records of user Bob, virtual operator ABC, and operator A.

Upon receipt of the above charging information records and after being processed, the billing system sends to user Bob, virtual operator ABC, and operator A their corresponding bills.

It thus can be seen that with only one merged charging system S1, various types of charging can be completed simultaneously to thereby realize the merging of the B2C charging and the B2B charging.

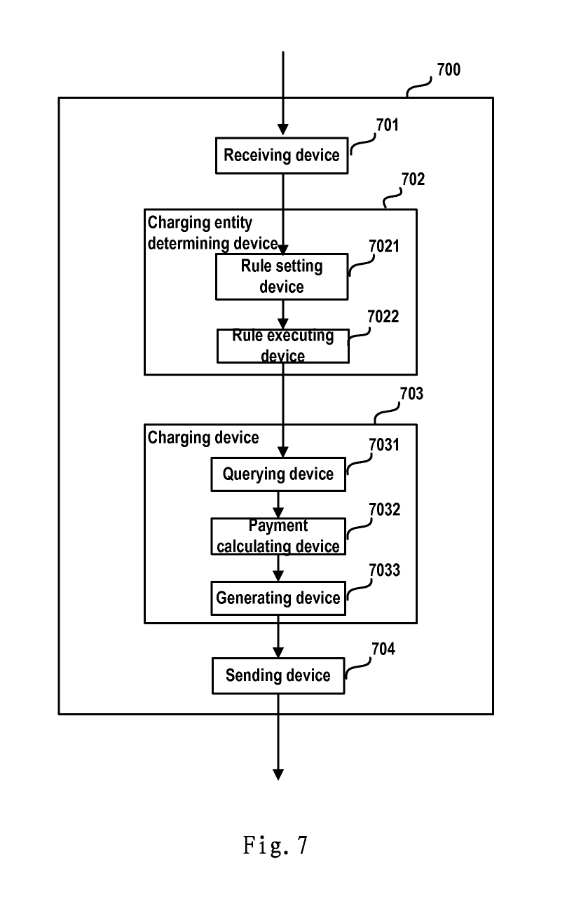

FIG. 7 shows a structural block diagram of an apparatus for processing a charging request in a server S according to one specific embodiment of the present invention. In FIG. 7, the apparatus 700 comprises a receiving device 701, a charging entity determining device 702, a charging device 703, and a sending device 704.

Hereinafter, the operating process of the apparatus 700 will be described in detail in conjunction with FIG. 2.

First, the receiving device 701 receives a charging request from a network 1. The charging request is directed to a session or a user event. The charging request may include, but not limited to, one or more of the following information:
caller identification, for example, the MSIDSN, IMSI, and MDN of the caller, etc.;
callee identification, for example, the MSIDSN, IMSI, and MDN of the callee, etc.;
call direction, for example, outgoing or incoming, etc.;
APN (access point number), and this entry is merely directed to data;
user location information, for example, Cell number, MCC, MNC, etc.;
user equipment information, for example, Apple smartphone, etc.;
network information, for example, the address of Serving-Gateway;
identification of an interconnect operator;
network resource use information, for example, call duration, data upload/download traffic, a number of pieces of SMS/MMS, etc.;
access technology, for example, traditional voice, GPRS, UMTS, LTE, WLAN, etc.;
Qos (Quality of Service);
service type, for example, voice, SMS, MMS, IMS, PoC, content, application, ring tone, etc.;
service provider information, for example, identification of merchants, identification of content providers, and identification of application providers, etc.

Next, the charging entity determining device 702 determines the types of all charging activities related to the charging request and a charging entity corresponding to each type of the charging activities according to the information contained in the charging request, wherein the information for determining the types of charging activities and the charging entity corresponding to each type of the charging activities may be any in the information included in the abovementioned charging requests, but not limited thereto.

Alternatively, the types of the charging activities comprise one of the following types:
end user charging;
wholesale charging;
revenue sharing charging;
interconnect settlement charging;
roaming charging.

Then, the charging device 703 charges all charging entities as determined by the charging entity determining device 702 to generate a piece of charging information record for each of the charging entities.

Next, the sending device 704 sends all charging information records generated by the charging device 703 to a billing system B.

In one embodiment, the charging entity determining device 702 further comprises a rule setting device 7021 and a rule executing device 7022.

The rule setting device 7021 pre-sets a plurality of rules that are in one-to-one correspondence with a certain type of the charging activities, for determining a charging entity corresponding to that type of the charging activities. Hereinafter, a set of rules as preset in the rule setting device 7021 will be listed exemplarily, wherein rule 1 corresponds to the end user charging; rule 2 corresponds to the wholesale charging; rule 3 corresponds to the revenue sharing charging; rule 4 corresponds to the interconnect settlement charging; and rule 5 corresponds to the roaming charging.

Rule 1: IF <Condition 1> THEN <paying party=caller, charging party=operator>.

Rule 2: IF <Condition 2> THEN <paying party=virtual operator, charging party=operator>.

Rule 3: IF <Condition 3> THEN <paying party=content provider, charging party=operator>.

Rule 4: IF <Condition 4> THEN <paying party=operator A, charging party =operator B>.

Rule 5: IF <Condition 5> THEN <paying party=mobile operator A1, charging party=mobile operator A2>.

The rule executing device 7022 executes all of the above rules in sequence based on the information contained in the charging request; for the rules whose conditions are met, their corresponding charging entities are determined. For example, for a set of rules as exemplarily listed above, the server S will execute rule 1, rule 2, rule 3, rule 4, and rule 5 in sequence, and if the conditions in rule 1 and rule 5 are satisfied, then corresponding to the two rules, the server S will determine the charging entities corresponding to rule 1 and rule 5, respectively.

In one embodiment, the charging device 703 further comprises a querying device 7031, a fee calculating device 7032, and a generating device 7033.

For each of the charging entities determined by the charging entity determining device 702, the querying device 7031 will query the charging plan and account information corresponding to the charging entity. The querying device 7031 will query a charging plan corresponding to the charging entity as maintained in a database (not shown) according to the identification of the charging entity, for example, the fee per minute or the fee per byte, etc., and meanwhile query its corresponding account information, i.e., such information as the current account balance of the charging entity.

Then, the fee calculating device 7032 calculates the fee information for the current usage based on the charging plan obtained by the querying device 7031, and updates the account information corresponding to the charging entity. The fee calculating device 7032 may calculate the fee information for the current usage based on the charging plan and the information contained in the charging request, and then correspondingly deduct the fee information for the current usage from the account balance corresponding to the charging entity.

Next, the generating device 7033 generates a piece of charging information record corresponding to the charging entity based on the fee information for the current usage and the updated account information. The charging information record may include, but not limited to, one or more of the following information:
information contained in the charging request;
account information, for example, such information as account identification, balance, outstanding payment, etc.;
a charging plan, for example, a fee per minute, a fee per byte, and a fee per SMS, etc.;
fee information for the current usage, for example, a fee before discounting, a fee after discounting, discounted amount, discounting ratio, etc.

It is apparent to those skilled in the art that the present invention is not limited to the details of the above exemplary embodiments, and without departing from the spirit or basic features of the present invention, other particular embodiments may be applied to implement the present invention. Thus, from any perspective, the embodiments herein should be regarded as exemplary and non-limiting, and the scope of the present invention should be limited by the appended claims instead of the above description; accordingly, all variations intended to fall within the meanings and scopes of equivalent elements of the claims should be covered within the present invention. Besides, it is apparent that the term “comprise”, “include” or “contain” does not exclude other units or steps, and a singular form does not exclude the plural. Terms such as first and second are used to denote names, instead of any particular sequence.

1. A method for processing a charging request in a server, the method comprising:
receiving a charging request for a session or a user event;
determining types of all charging activities related to the charging request and a charging entity corresponding to each type of the charging activities according to information contained in the charging request;
charging all the determined charging entities simultaneously and generating a piece of charging information record for each of the charging entities; and
sending the charging information records.

2. The method according to claim 1, wherein determining further comprises:
presetting a plurality of rules that are in one-to-one correspondence with one type of the charging activities; and
executing the plurality of rules based on the information contained in the charging request, and for a rule whose condition is met, determining its corresponding charging entity.

3. The method according to claim 1, wherein charging further comprises: for each of the determined charging entities, performing:
querying a charging plan and account information corresponding to the charging entity;
calculating fee information for current usage based on the charging plan, and updating the corresponding account information; and
generating a piece of charging information record based on the fee information for the current usage and the updated account information.

4. The method according to claim 1, wherein the types of the charging activities comprise one of the following types: end user charging, wholesale charging, revenue sharing charging, interconnect settlement charging, and roaming charging.

5. The method according to claim 1, wherein the information contained in the charging request comprises at least one or more of the following information:
caller identification, callee identification, user location information, whether being in a roaming state, a call direction, interconnect operator identification, network information, information of the used services, service provider information, and amount of the used network resources.

6. The method according to claim 1, wherein the charging information record comprises at least the following information:
account information, a charging plan, and fee information for current usage.

7. An apparatus for processing a charging request in a server, the apparatus comprising:
a receiving device configured to receive a charging request for a session or a user event;
a charging entity determining device configured to determine types of all charging activities related to the charging request and a charging entity corresponding to each type of the charging activities according to information contained in the charging request;
a charging device configured to charge all the determined charging entities simultaneously and generate a piece of charging information record for each of the charging entities; and
a sending device configured to send the charging information records.

8. The apparatus according to claim 7, wherein the charging entity determining device further comprises:
a rule setting device configured to preset a plurality of rules that are in one-to-one correspondence with one type of the charging activities; and
a rule executing device configured to execute the plurality of rules based on the information contained in the charging request, and for a rule whose condition is met, determine its corresponding charging entity.

9. The apparatus according to claim 7, wherein a fee calculating device further comprises a querying device, a charging device, and a generating device, wherein for each of the determined charging entities,
the querying device is configured to query a charging plan and account information corresponding to the charging entity;
the fee calculating device is configured to calculate fee information for current usage based on the charging plan, and update the corresponding account information; and
the generating device is configured to generate a piece of charging information record based on the fee information for the current usage and the updated account information.

10. The apparatus according to claim 7, wherein the types of the charging activities comprise one of the following types: end user charging, wholesale charging, revenue sharing charging, interconnect settlement charging, and roaming charging.

11. The apparatus according to claim 7, wherein the information contained in the charging request comprises at least one or more of the following information:
caller identification, callee identification, user location information, whether being in a roaming state, a call direction, interconnect operator identification, network information, information of the used services, service provider information, and amount of the used network resources.

12. The apparatus according to claim 7, wherein the charging information record comprises at least the following information:
account information, a charging plan, and fee information for current usage.
